(19) United States
(12) Patent Application Publication
(10) Pub. No.: US 2026/0196199 A1
(43) Pub. Date: Jul. 9, 2026

(54) Passive Switchless Hum-Cancellation Devices for Retrofitted Installation in Single-Coil Electric Guitar Pickup Circuits

(71) Applicant: BzzzzKill Inc., Winipeg (CA)

(72) Inventor: Richard Moreton, Winnipeg (CA)

(21) Appl. No.: 19/408,833

(22) Filed: Dec. 4, 2025

Related U.S. Application Data
(60) Provisional application No. 63/741,599, filed on Jan. 3, 2025.

(51) Int. Cl. G10H 3/18

(52) U.S. Cl. CPC G10H 3/181; G10H 3/182

(57) ABSTRACT

A hum cancellation device is provided for incorporation into an electric guitar pickup circuit characterized by a pickup selector switch and a plurality of single-coil pickups, each having a positive lead connected to the selector switch. The hum-cancellation device is devoid of any magnetic poles and comprising an additional bobbin and at least one dummy coil wrapped therearound. Each dummy coil has an input end connected to the negative lead of at least one single-coil pickup, and an opposing output end connected to ground. The negative lead of each single-coil pickup is wired to the hum-cancellation device, and a winding direction of each dummy coil, from the output end to the input end, is opposite, as viewed from a same reference plane, to a pickup winding direction, from the negative end to the positive end, of each single-coil pickup to which the input end of said dummy coil is connected.

### CROSS-REFERENCE TO RELATED APPLICATIONS

### This application claims benefit under 35 U.S.C. 119(e) of U.S. Provisional Application No. 63/741,599, filed January 3, 2025, the entirety of which is incorporated herein by reference

### FIELD OF THE INVENTION

The present invention relates generally to pickups for electric guitars, and more particularly to solutions for eliminating problematic hum from single-coil pickups.

### BACKGROUND

In a conventional electric guitar, the vibration of the instruments steel strings is converted into an electrical signal by one or more pickups, each of which comprises at least one coil of wire wrapped around a set of magnetic pole pieces. The strings pass through the magnetic field of the pickup, and when played, vibrate within this magnetic field, thereby producing electrical signals in the coil(s) of the pickup that correspond to the notes being played. Single-coil pickups are a category of pickup characterized by presence of only a singular coil, and are susceptible to ambient electromagnetic interference (EMI) arising from other electrical devices operating in proximity to the guitar and powered by alternating current (AC), which generates a problematic “hum” at the frequency of such AC power (e.g. 60 Hz in North America). Another category of pickup, known as the humbucker, instead has two coils wrapped in opposite directions around respective pole piece sets oriented in opposing polarity to one another, with the result that the hum generated in the two coils are of opposite phase and thus cancel one another out, while the electrical signals generated in the two coils by the string vibration in the magnetic fields are of matching phase, thus maintaining signal integrity. While humbuckers are effective at hum cancellation, the tonal character differs notably between single-coil pickups and multi-coil humbucker pickups.

A common pickup layout used in many electric guitars, most recognizably in the iconic and extremely popular Fender Stratocaster^{TM}, is a layout of three single-coil pickups, one occupying a neck position nearest to the neck of the guitar, another occupying a bridge position furthest from the neck and nearest to the bridge of the guitar, and another occupying a middle position between the neck and bridge positions.

In many instances, the single-coil pickup in the middle position is of reverse-wound, reverse-polarity (RWRP) relation to the single-coil pickups in the neck and bridge positions, meaning that the singular coil of this middle pickup is wound in the opposite direction to the coils of the neck and bridge pickups, and the magnetic pole pieces of this middle pickup are oriented in reverse polarity to those of the neck and bridge pickups. In such cases, the pickup circuit typically includes a five-way selector switch, three positions of which each connect only a singular respective one of the three pickups in the circuit (single-pickup positions), and the remaining two position of which each connect both the middle pickup and a respective one of neck and bridge pickups in the circuit (dual-pickup positions). Given the RWRP relationship of the middle pickup to both the neck and bridge pickups, the latter dual-pickup positions notably reduce the hum, compared to the single-pickup switch position, based on the same operating principle described above for humbucker pickups. In other instances, the middle pickup is not of RWRP relationship to the neck and bridge pickups, and there is no hum reduction in the dual-pickup switch positions.

U.S. patent 5,898,121 assigned to Gibson Guitar Corp. discloses redesign of a two single-coil pickup circuit to introduce an extra dummy coil, devoid of any magnetic pole pieces, beneath the top surface of the guitar body and between the single-coil neck and bridge pickups for hum cancellation purposes, with a particular switching scheme for pairing two of the coils, in reverse wound relationship to one another, in each of three different switch positions. The patent provides no retrofit solution for an existing three-pickup guitar with a five-way switch setup.

U.S. patent 5,569,872 assigned to Ernie Ball, Inc. discloses a pickup circuit that incorporates a secondary coil for noise cancelling purposes, but prescribes isolation of the primary and secondary coils into separate respective circuits, and involves use of active electronic componentry necessitating incorporation of a power supply, and more particularly a nine-volt battery, for the active circuit requirements of this hum cancelling design.

Reference in the preceding patent is made to earlier U.S. Patent 4,581,975 by Leo Fender, which teaches incorporation of two dummy coils into two respectively dedicated cavities each situated between a respective two of a total three single-coil pickups of the guitar, which cavities denote notable deviation from typical guitar body design. The patented solution also prescribes inclusion of a preamplifier, again denoting an active circuit component necessitating incorporation of a power supply into the pickup circuit.

Outside the patent literature, incorporation of a dummy coil into a conventional three single-coil pickup arrangement, without necessitating active circuitry and associated power supply, has been proposed, and example of which can be seen at www.frettech.com/frettech/dummy/index.html, which prescribes the installation of the dummy coil into the existing control cavity of the guitar body where the wiring terminal sides of the pickup selector switch and volume and tone potentiometers reside, with wiring of the dummy coil in a hot side of the pickup circuit between the volume potentiometer and the pickup selector switch, in accompaniment by an added single-pole, single-throw (SPST) switch by which the dummy coil can be selectively connected in only the single-pickup positions, and instead be bypassed in the dual-pickup positions. Admission is made that the dummy coil in this setup does negatively impact the frequency response of the single-coil pickups.

There remains an unfulfilled need in the art for a solution by which a three single-coil pickup circuit of an existing guitar, like the popular Fender Stratocaster^{TM}, can be modified, without replacement of the existing pickups thereof, to eliminate or substantially reduce hum in the circuit’s single-pickup switch positions, ideally with zero or minimal effect on tone, and without requiring active circuitry or alteration of the guitar body to accommodate such modification, this maintaining the integrity of the original instrument while delivering superior audio quality.

### SUMMARY OF THE INVENTION

According to a first aspect of the invention, there is provided a pickup circuit for an electric guitar, said circuit comprising: a pickup selector switch; a plurality of single-coil pickups each having a pickup bobbin, plurality of magnetic pole pieces, a respective singular pickup coil wrapped around said bobbin and said magnetic pole pieces, a positive lead connecting a positive end of the respective singular coil to the pickup selector switch, and a negative lead connected to an opposing negative end of the respective singular pickup coil; and a hum-cancellation device devoid of any magnetic poles and comprising an additional bobbin and at least one dummy coil wrapped around said additional bobbin, each dummy coil having an input end connected to the negative lead of at least one of the single-coil pickups, and an opposing output end connected to ground; wherein the negative lead of each of the plurality of single-coil pickups is wired to the hum-cancellation device, and a dummy coil winding direction possessed by each dummy coil, from the output end thereof to the input end thereof, is opposite, as viewed from a same reference plane, to a pickup coil winding direction possessed by the respective singular pickup coil, from the negative end thereof to the positive end thereof, of each of the at least one of the single-coil pickups to which the input end of said dummy coil is connected.

According to a second aspect of the invention, there is provided a method of modifying an electric guitar to mitigate single-coil pickup hum in a pickup circuit of said electric guitar, said method comprising: on a ground side of said pickup circuit, at which negative leads of a plurality of a single-coil pickups are connected to ground, in contrast to a hot side of the pickup circuit at which positive leads of said single-coil pickups are connected to a pickup selector switch, performing installation of a hum-cancellation device that is devoid of any magnetic pole pieces and comprises one or more dummy coils each having opposite input and output ends, between which the dummy coil is wound around a bobbin of said hum-cancellation device in a dummy coil winding direction from the output end thereof to the input end thereof, said installation comprising: decoupling the negative leads of the single-coil pickups from ground; and in any order: connecting the negative lead of each one of the single-coil pickups to an input end of one of the one or more dummy coils whose dummy coil winding direction is opposite, as viewed in a same reference plane, to a pickup coil winding direction in which a respective pickup coil of said one of the single-coil pickups is wound from a negative end of said respective pickup coil, to which the negative lead is connected, to a positive end of said respective pickup coil, from which a positive lead connects said respective pickup coil to a pickup selector switch; and connecting the output end of each of the one or more dummy coils to ground.

According to a third aspect of the invention, there is provided a dual-coil hum-cancellation device for hum cancellation purposes in electric guitar pickup circuits with single-coil pickups, said dual-coil hum-cancellation device comprising a shared bobbin devoid of any magnetic pole pieces, and two wire coils both wound around said shared bobbin.

According to a fourth aspect of the invention, there is provided a method of providing a customer with an optimally selected or customized hum-cancellation device intended for installation in a pickup circuit of an electric guitar for hum cancellation purposes, said method comprising: receiving from a customer indication of at least one characteristic of the pickup circuit; and performing case-specific selection or customization of the hum-cancellation device, for ultimate provision thereof to the customer, according to said at least one characteristic of the pickup circuit; wherein said at least one characteristic of the pickup circuit comprises identified presence or absence in said pickup circuit of a reverse wound single-coil pickup whose coil winding directionally is opposite that of any other single-coil pickup in the pickup circuit, and selecting or customizing the hum-cancellation device to have either a singular dummy coil for instances characterized by absence of a reverse-wound single coil pickup, or two dummy coils, of reversely wound relationship to one another, for instances characterized by presence of a reverse-wound single-coil pickup.

### BRIEF DESCRIPTION OF THE DRAWINGS

Preferred embodiments of the invention will now be described in conjunction with the accompanying drawings in which:

FIG. 1 is a schematic diagram of an electric guitar pickup circuit with a retrofit dummy coil installation according to a first embodiment of the invention for hum cancellation purposes in an electric guitar with three single-coil pickups whose coils are all wound in the same direction.

FIG. 2 is a schematic diagram of another electric guitar pickup circuit with a retrofit dummy coil installation according to a second embodiment of the invention, for equivalent hum cancellation purposes as the first embodiment, but in an electric guitar where a middle one of the three single-coil pickups is of reverse-wound, reverse polarity (RWRP) relation to the other two pickups.

### DETAILED DESCRIPTION

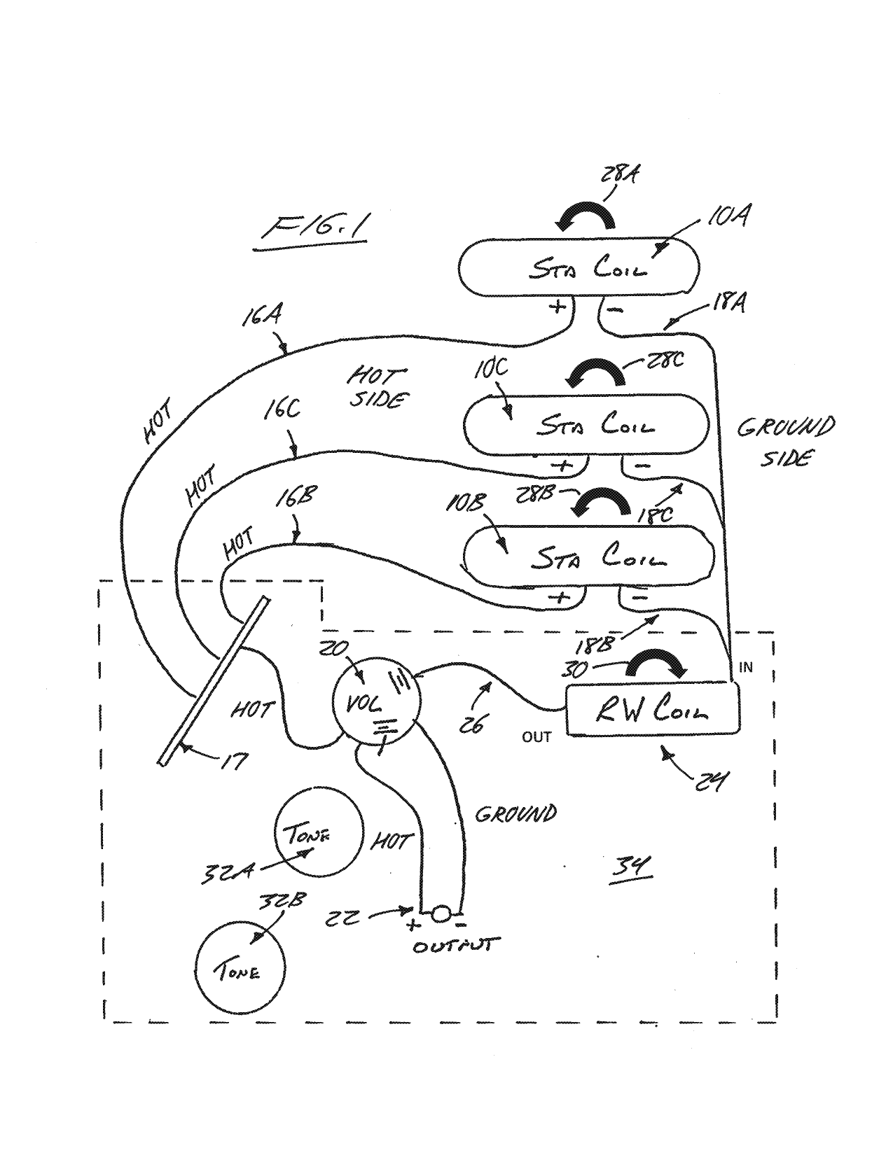

FIG. 1 shows a first embodiment of a pickup circuit of an electric guitar having three single-coil pickups whose coils all share a common winding directionality with one another. In known fashion, the three pickups are distinguishable from one another in terms of the respective positions they occupy on the guitar body, and thus are individually referred to herein as a neck pickup 10A residing nearest the neck of the electric guitar, a bridge pickup 10B residing furthest from the neck of the electric guitar and nearest to a bridge thereof, and a middle pickup 10C residing intermediately between the neck and bridge pickups 10A, 10B at a spaced distance from each thereof. Each pickup has a respective positive lead wire 16A, 16B, 16C running from the pickup to a five-way pickup selector switch 17, and a respective negative lead wire 18A, 18B, 18C that, in a conventional pickup circuit is typically soldered to a metal housing of a volume potentiometer 20 of the pickup circuit, which serves as a shared grounding hub to which a respective lead wire from a negative terminal of an output jack 22 of the pickup circuit is typically is also soldered so that all of the pickups are grounded to the negative (ground) terminal of the output jack 22. Also typically soldered to this shared grounding hub is an additional grounding wire (not shown) for grounding the strings of the guitar, for example by soldering of the other end of this ground wire to a metal spring claw (not shown) that is screwed into the wood body of the guitar to serve as an anchoring point for first ends of a set of tensioning springs whose opposing second ends are coupled to a tremolo bridge of the guitar (not shown). In fixed-bridge setups, this grounding wire can be attached directly to the bridge itself.

In retrofitting an existing guitar with the first embodiment pickup circuit of FIG. 1, the negative lead wires 18A-18C of the three single-coil pickups 10A-10C are first decoupled (unsoldered) from their usually shared grounding hub (typically the volume potentiometer housing), and are then instead commonly connected to an input of a single-coil hum-cancellation device 24, an output of which is in turn wired to ground with the negative terminal of the output jack. In the illustrated example, this grounding of the output of the hum-cancellation device is achieved via an output lead wire 26 that has one end connected to the output of the hum-cancellation device 24, and the other end soldered to the same shared grounding hub (typically the volume potentiometer housing) to which the negative terminal of the output jack 22 is also wired, and from which the negative lead wires 18A-18C of the pickups 10A-10C were previously decoupled. Like a single-coil pickup, the single-coil hum-cancellation device 24 has a bobbin around which a singular wire coil is wrapped, but unlike a pickup, is devoid of any magnetic pole pieces. To distinguish the bobbin of the hum-cancellation device 24 from the bobbins of the pickups 10A-10C, the latter may be referred to herein as pickup bobbins and the former instead referred to herein as an additional or dummy coil bobbin, regardless of whether or note the bobbins differ from one another in any way other than the presence and absence of magnetic pole pieces in the pickup bobbins and the dummy coil bobbin, respectively.

An input end of the singular wire coil of the single-coil hum-cancellation device 24 refers to the end thereof to which single-coil pickups 10A-10C are wired by their respective negative lead wires 18A-18C, and an opposing output end of this singular wire coil of the single-coil hum-cancellation device 24 refers to the end thereof that is conductively connected to ground, typically via soldered coupling of output lead wire 26 to the shared grounding hub (typically the volume potentiometer housing). The directionality in which the single-coil of the single-coil hum-cancellation device 24 is wound around the dummy coil bobbin from the output end of that coil to the input end of that coil is of reversed relationship to the directionality in which the single-coil of each of the three single-coil pickups 10A-10C is wound around the pickup bobbin from the negative end of that pickup coil (meaning the end to which the respective negative lead wire 18A-18C is coupled) to the positive end of that pickup coil (meaning the end to which the respective positive lead wire 16A-16C is coupled), when viewing the three pickups 10A-10C and the hum-cancellation device 24 from a common reference plane (e.g. from the top or bottom of the guitar body, of which the illustrated figure may be interpreted as a bottom view of a right-handed guitar or a top view of a left-handed guitar).

In the illustrated example, such coil directionalities are schematically represented by three matching directional arrows 28A-28C for the three pickup coils (all shown with a counterclockwise winding directionality, as viewed from the bottom of a right handed guitar, in the non-limiting example of the illustration), and a singular counter-directional arrow 30 for the hum-cancellation device 24 (showing a clockwise winding directionality from that same bottom reference plane). Use of a “negative to positive” (or “ground to hot”) convention in labelling of the pickup coil winding direction is a common one, hence using this same convention herein with a matching “output to input” (which may likewise be referred to as “ground to hot”) convention for the coil directionality of the hum-cancellation device 24, but the same notion of the reversed directional relationship between the windings of the pickup coils and the dummy coil of the hum-cancellation device 24 may alternatively be expressed with a “positive to negative” convention for the pickups and “input to output” convention for the hum-cancellation device (meaning “hot to ground” for both).

The three positive lead wires 16A-16C of the three pickups 10A-10C remain wired to three terminals of the five-way pickup selector switch 17 in conventional fashion, as does the wiring of the volume potentiometer 20 to another wiring terminal of the pickup selector switch 17 and to the positive terminal of the output jack 22. The installation of the hum-cancellation device 24 necessitates no decoupling of these conventional connections, nor any rerouting of the associated wires, whereby a five-way implementation of the pickup selector switch 17 is workable in the same manner described in the foregoing background. A first position of the selector switch 17 is a single-pickup position placing only the neck pickup 10A of the three pickups 10A-10C in a closed circuit from the selector switch 17 to the output jack 22 (now via the hum-cancellation device 24), a second position of the selector switch 17 is a dual-pickup position placing only the neck and middle pickups 10A & 10C of the three pickups 10A-10C in a closed circuit from the selector switch 17 to the output jack 22 (now via the hum-cancellation device 24), a third position of the selector switch 17 is another single-pickup position placing only the middle pickup 10C of the three pickups 10A-10C in a closed circuit from the selector switch 17 to the output jack 22 (now via the hum- cancellation device 24), a fourth position of the selector switch 17 is another dual-pickup position placing only the bridge and middle pickups 10B & 10C of the three pickups 10A-10C in a closed circuit from the selector switch 17 to the output jack 22 (now via the hum-cancellation device 24), and the fifth and final position is another single-pickup position placing only the bridge pickup 10B of the three pickups 10A-10C in a closed circuit from the selector switch 17 to the output jack 22 (now via the hum-cancellation device 24).

Using the term “active” as shorthand to refer to the status of any pickup connected in a closed circuit between the selector switch 17 and the output jack 22 in any given position of the selector switch 17 (as opposed to commonly known use of the term “active pickup” to mean a pickup reliant on a power source, unlike the single-coil pickups 10-10C herein that are “passive pickups” and are unaccompanied by any power source in the pickup circuit), the switching scheme of the inventively modified pickup circuit, to which the hum-cancellation device 24 has been added on the ground side of the circuit between the pickups and ground, differs from the original pre-modification pickup circuit in that the installed hum-cancellation device 24 is always connected between the one or two active pickups of any given switch position and the negative (ground) terminal of the output jack 22.

The novel installation of the hum-cancellation device on the ground side of the circuit has been found by the applicant to effectively cancel single-coil pickup hum in all three single-pickup positions, with no perceptible detriment to tone or frequency response in any of all five selector switch positions, all achieved by simple installation of solely the hum-cancellation device 24, in a switchless and non-bypassable fashion remaining permanently “on” at all times, with no need to supplement the existing pickup selector switch with any additional switching componentry to install or operate to selectively switch the hum-cancellation device 24 on and off depending on which pickup(s) is/are active. Applicant has found the dummy coil to be particularly effective when the dummy coil is custom-tailored to the particular guitar to have a coil resistance measuring between 60 and 80 percent of the resistance possessed by an individual one of the single coil pickups.

Aside from decoupling of the negative leads 18A-18C of the pickups from their original points of grounded connection to the output jack 22, all wiring among the volume potentiometer 20 and the accompanying tone potentiometers 32A, 32B can be left in its original state, hence omission of such tone control wiring details in the figure, given that such details are completely unaffected by retrofitted installation of the hum-cancellation device 24. Since the modification of the original pickup circuit involves only the installation of the hum-cancellation device 24, with no additional switching componentry that need be accessed by the user during playing of the guitar, the entirety of the added retrofit componentry (the hum-cancellation device 24, and its output lead wire 26) can be installed entirely and exclusively within the same control cavity 34 of the guitar body in which the wiring terminal sides of the pickup selector switch 17, volume potentiometer 20 and tone potentiometers 32A, 32B all reside, with zero need to alter the guitar body in any way. Installation requires only temporary opening of the control cavity 34, decoupling of the negative lead wires 18A-18C of the three pickups 10A-10C from their existing grounding point(s), resoldering of these three negative lead wires 18A-18C to the input of the hum-cancellation device 24, and soldering of the attached output lead wire 26 into grounded connection to the negative terminal of the output jack 22, for example by soldered attachment to the shared grounding hub presently embodied by the housing of the volume potentiometer 20.

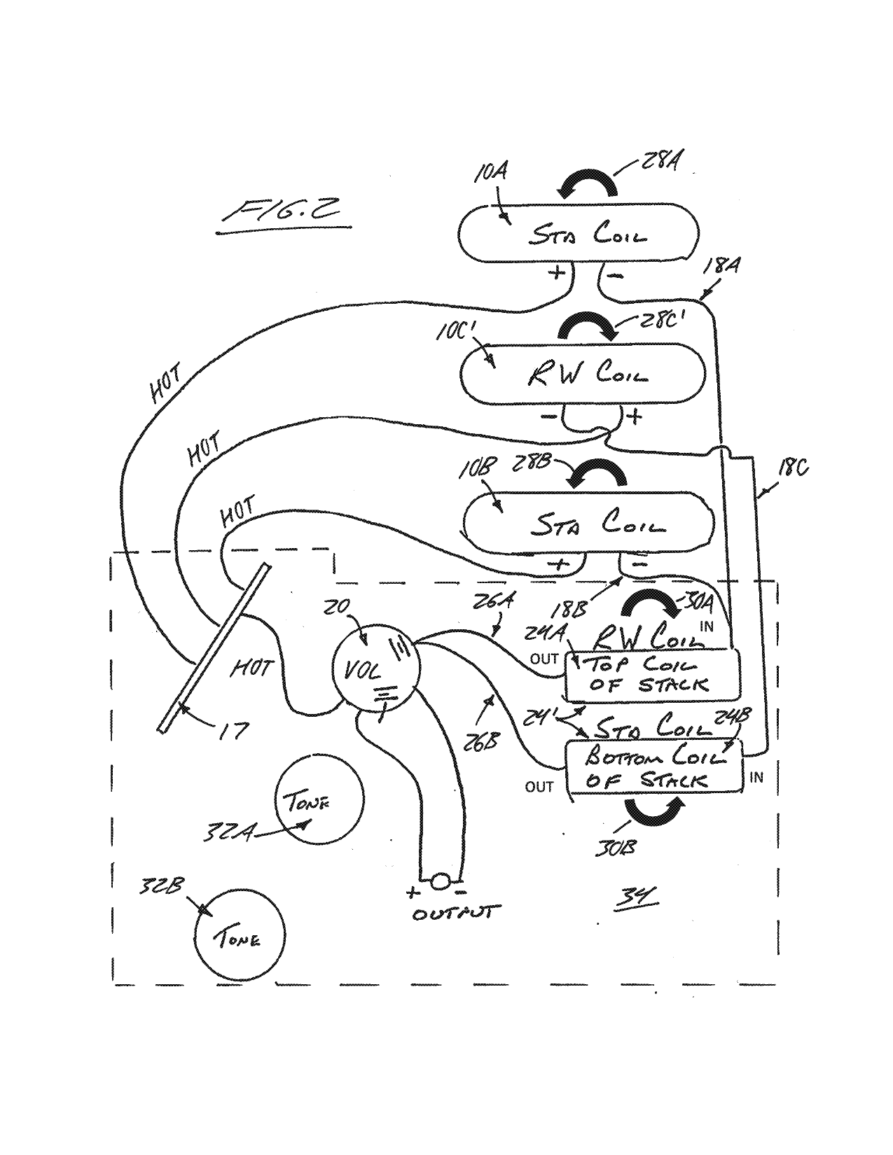

FIG. 2 illustrates another embodiment of a retrofit installation of a hum- cancellation device 24’ into the ground side of an existing three-pickup pickup circuit of an electric guitar, but this time in a guitar whose middle pickup 10C’ is of reverse-wound, reverse-polarity (RWWP) relationship to the neck pickup 10A and the bridge pickup 10B. Whereas the preceding embodiment with three pickups of matching wind directionality featured a single-coil hum-cancellation device 24, this embodiment instead features a dual-coil hum-cancellation device 24’ having two coils of opposite coil winding directionality to one another, but preferably embodied together in a singular unit having a singular dummy coil bobbin around which both of these dummy coils are commonly wound, in stacked relationship with one dummy coil 24A situated above the other 24B. In the illustrated example of this, a top dummy coil 24A of the dual-coil hum-cancellation device 24’ is shown with a clockwise output-to-input (or ground to hot) coil directionality 30A of opposing (reverse) relationship to the counterclockwise negative-to-positive (or ground to hot) coil directionality 28A, 28B of the neck and bridge pickups 10A, 10B, while a bottom dummy coil 24B of the dual-coil hum-cancellation device 24’ is shown with a counterclockwise output-to-input (or ground to hot) coil directionality 30B of opposing or reverse relationship to a clockwise negative-to-positive (or ground to hot) coil directionality 28C’ of the RWRP middle pickup 10C’.

In this example, the negative lead wires 18A, 18B from the neck and bridge pickups 10A, 10B are therefore both connected to the input end of the top dummy coil 24A of the dual-coil hum-cancellation device 24’, owing to the opposing dummy coil directionality 30A of the top dummy coil 24A relative to the pickup coil directionality 28A, 28B of the neck and bridge pickups 10A, 10B, while the negative lead wire 18C from the RWRP middle pickup 10C’ is instead connected to the input end of the bottom dummy coil 24B of the dual-coil hum-cancellation device 24’, owing to the opposing dummy coil directionality 30B of the bottom dummy coil 24B relative to the pickup coil directionality 28C’ of the RWRP middle pickup 10C. The output ends of both dummy coils 24A, 24B are grounded to the negative terminal of the output jack 22, in the illustrated example by two output lead wires 26A, 26B whose proximal ends are respectively coupled to the output ends of the two dummy coils 24A, 24B, and whose distal ends are both soldered to the shared grounding hub, as embodied in the illustrated example by the metallic housing of the volume potentiometer 20.

While the illustrated example has the top dummy coil 24A being of reversely wound relationship to the neck and bridge pickups 10A, 10B, and thus wired thereto, and the bottom dummy coil 24B being of reversely wound relationship to the middle pickup 10C, and thus wired thereto, this configuration may alternatively be reversed without detriment to the functional result of using one of the two dummy coils 24A to cancel the single-coil pickup hum of the neck pickup 10A and the bridge pickup 10B in the two single-pickup selector switch positions in which those pickups are respectively active, and using the other dummy coil 24B to cancel the single-coil pickup hum of the middle pickup 10C in the other single-pickup selector switch position.

As with the single-coil hum-cancellation device 24 of the preceding embodiment, the dual-coil hum-cancellation device 24’ in this embodiment is also installed in a switchless, non-bypassable, permanently active relationship between single-coil pickups and the negative/ground terminal of the output jack 22 of the pickup circuit. Accordingly, the pickup selector switch 17 is the only switch of the circuit, which lacks any additional switch for selectively switching the hum-cancellation device 24 in and out of the circuit. While one of the two dummy coils 24A, 24B is bypassed in each of the three single-pickup positions of the pickup selector switch 17, the other one of the two dummy coils is always actively connected in such instances, whereby the totality of the hum-cancellation device 24’ is never bypassed in its entirety. In each of the two dual-pickup positions of the pickup selector switch 17, both dummy coils 24A, 24B are actively connected in the circuit.

As with the preceding embodiment, retrofitting of an existing guitar’s pickup circuit with the hum-cancellation device 24’ is extremely simple, requiring again only decoupling of the negative lead wires 18A-18C of the three pickups 10A-10C from their existing ground connection(s), resoldering of those negative lead wires 18A-18C to the two inputs of the dual-coil hum-cancellation device 24’ in properly mapped relation according to the dummy coil winding directionalities thereof relative to the pickup coil winding directionality, and grounding the two outputs of the hum-cancellation device 24’ to the negative terminal of the output jack 22, typically by soldering of the output lead wires 26A, 26B of the dual-coil dummy device 24’ to the shared grounding hub (typically embodied by the volume potentiometer housing) to which the negative terminal of the output jack 22 is wired, and from which the negative lead wires 18A-18C of the pickups 10A-10C were decoupled. As with the preceding embodiment, the entirety of the added retrofit componentry (the hum-cancellation device 24’ and its output lead wires 26A, 26B) can be installed entirely and exclusively within the same control cavity 34 shared by the existing control componentry of the pickup circuit (the pickup selector switch 17, volume potentiometer 20 and tone potentiometers 32A, 32B) with zero need to alter the guitar body in any way.

To guide proper user installation, the two different inputs of the dual-coil hum-cancellation device 24’ may be suitably marked for user instruction on which pickup(s) to connect to which input, for example with labelling of “neck/bridge” or “outer” at the input connection to which the “outer” neck and bridge pickups are to be wired, and with labelling of “middle” or “center” at the other input connection to which the middle pickup is to be wired, or with optional abbreviation of such designations, such as N=neck, B=bridge, M=middle, O=outer, C=center, or using any other suitable indicia representative of the different pickups (e.g. three bars representing the three pickups, with colour highlighting of which of the three thereof to connect to the given input). In contrast, the input and output of the single-coil hum-cancellation device 24 of the preceding embodiment need not specify particular subsets of the pickups to connect to different inputs, and thus may have a more generic marking such as “input”, “pickups” or “positive” (e.g. optionally abbreviated as “in”, “PU”, “pos” or “+”) at the input connection. In either embodiment, the hum-cancellation device 24, 24’ may have the output lead wire(s) 26, 26A, 26B pre-attached thereto during manufacture, in which case marking of the output connection(s) as “output”, “ground” or “negative” (e.g. optionally abbreviated as “out”, “GRD” or “neg”) is not necessary for installation guidance, and may optionally be omitted, or replaced with marking or color coding of the output lead wire(s) itself.

The manufacturer can optionally choose to custom make each hum-cancellation device 24, 24’ according to customer shared characteristics of the existing pickup circuit of an existing guitar that the customer wants to retrofit, for example based on customer specification of whether the existing pickup circuit has an RWRP middle pickup or not (based on which the manufacturer knows whether to make the single-coil or dual-coil version of the hum-cancellation device 24, 24’), and optionally further based on customer measurement or lookup of the coil resistance of at least one single-coil pickup in the existing pickup circuit, or customer identification of the type of single-coil pickup concerned from which the manufacturer can source a known coil resistance thereof or measure a reference example of that pickup type, in order to custom wind a hum-cancellation device whose coil resistance optimally measures between 60 and 80 percent of that pickup coil resistance. Alternatively, the product may be produced on a non-customized basis, in which case both single-coil and dual-coil models may be produced in different versions of characterized by different electrical resistance values of the coils, at preselected values known to measure approximately 60 to 80% of popular single-coil pickups, in which the manufacturer of the product (in a direct to customer business model) or retailer may select which model and version to deliver to the customer based on the received details of the pickup circuit to the customer is looking to modify.

Since various modifications can be made in the invention as herein above described, and many apparently widely different embodiments of same made, it is intended that all matter contained in the accompanying specification shall be interpreted as illustrative only and not in a limiting sense.

1. A pickup circuit for an electric guitar, said circuit comprising:
a pickup selector switch;
a plurality of single-coil pickups each having a pickup bobbin, plurality of magnetic pole pieces, a respective singular pickup coil wrapped around said bobbin and said magnetic pole pieces, a positive lead connecting a positive end of the respective singular coil to the pickup selector switch, and a negative lead connected to an opposing negative end of the respective singular pickup coil; and
a hum-cancellation device devoid of any magnetic poles and comprising an additional bobbin and at least one dummy coil wrapped around said additional bobbin, each dummy coil having an input end connected to the negative lead of at least one of the single-coil pickups, and an opposing output end connected to ground;
wherein the negative lead of each of the plurality of single-coil pickups is wired to the hum-cancellation device, and a dummy coil winding direction possessed by each dummy coil, from the output end thereof to the input end thereof, is opposite, as viewed from a same reference plane, to a pickup coil winding direction possessed by the respective singular pickup coil, from the negative end thereof to the positive end thereof, of each of the at least one of the single-coil pickups to which the input end of said dummy coil is connected.

2. The circuit of claim 1 wherein the pickup selector switch is a sole switch of the circuit, and the hum-cancellation device is conductively connected to at least one of the single-coil pickups in each and every position of the pickup selector switch.

3. The circuit of claim 1 wherein the plurality of single-coil pickups comprises three single-coil pickups.

4. The circuit of claim 3 comprising an output jack from which audio signals are outputted from the circuit, wherein the pickup selector switch comprises a five-way pickup selector switch, a first position of which connects a first singular one of the three single-coil pickups in a closed circuit with the output jack via the hum-cancellation device, a second position of which connects a first pair of the three single-coil pickups in a closed circuit with the output jack via the hum-cancellation device, a third position of which connects a second singular one of the three single-coil pickups in a closed circuit with the output jack via the hum-cancellation device, a fourth position of which connects a second pair of the three single-coil pickups in a closed circuit with the output jack via the hum-cancellation device, and a fifth position of which connects a third singular one of the three single-coil pickups in a closed circuit with the output jack via the hum-cancellation device.

5. The circuit of claim 3 wherein the respective pickup coils of the three single-coil pickups are all wound in a same direction as one another, and the hum-cancellation device has only a singular dummy coil, the input end of which is connected to the negative leads of all three of the three single-coil pickups.

6. The circuit of claim 3 wherein:
the three single-coil pickups comprise an outer two pickups and middle pickup residing in a position between said outer two pickups;
the respective singular pickup coils of said outer two pickups are wound in the same direction as one another;
the respective singular pickup coil of the middle pickup is wound in a reverse direction to the respective singular pickup coils of said outer two pickups; and
the hum-cancellation device has two dummy coils of reversely wound relationship to one another, among which the input end of a first of said two dummy coils is connected to the negative leads of the outer two pickups, and the input end of a second of said two dummy coils is connected to the negative lead of the middle pickup.

7. The circuit of claim 6 wherein said two dummy coils reside in stacked relationship to one another.

8. The circuit of claim 1 wherein the hum-cancellation device resides within a same guitar body cavity shared by at least one of: said pickup selector switch, a volume potentiometer and one or more tone potentiometers.

9. The circuit of claim 8 wherein said same guitar body cavity is shared by at least two of said pickup selector switch, said volume potentiometer and said one or more tone potentiometers.

10. The circuit of claim 9 wherein said same guitar body cavity is shared by all three of said pickup selector switch, said volume potentiometer and said one or more tone potentiometers.

11. The circuit of claim 1 wherein an electrical resistance of each dummy coil measures between 60 and 80 percent of that possessed by the respective pickup coil of one of the pickups to which that dummy coil is wired.

12. A method of modifying an electric guitar to mitigate single-coil pickup hum in a pickup circuit of said electric guitar, said method comprising:
on a ground side of said pickup circuit, at which negative leads of a plurality of a single-coil pickups are connected to ground, in contrast to a hot side of the pickup circuit at which positive leads of said single-coil pickups are connected to a pickup selector switch, performing installation of a hum-cancellation device that is devoid of any magnetic pole pieces and comprises one or more dummy coils each having opposite input and output ends, between which the dummy coil is wound around a dummy coil bobbin of said hum-cancellation device in a dummy coil winding direction from an output end of the dummy coil to an input end thereof, said installation comprising:
decoupling the negative leads of the single-coil pickups from ground; and
in any order:
connecting the negative lead of each one of the single-coil pickups to the input end of one of the one or more dummy coils whose dummy coil winding direction is opposite, as viewed in a same reference plane, to a pickup coil winding direction in which a respective pickup coil of said one of the single-coil pickups is wound from a negative end of said respective pickup coil, to which the negative lead is connected, to a positive end of said respective pickup coil, from which a positive lead connects said respective pickup coil to a pickup selector switch; and
connecting the output end of each of the one or more dummy coils to ground.

13. The method of claim 12 wherein the installation of the dummy coil comprises switchless installation thereof in non-bypassable relationship between single-coil pickups and an output jack of the circuit such that the dummy coil remains conductively connected between the single-coil pickups and output jack at all times.

14. The method of claim 12 wherein the plurality of single-coil pickups comprises three single-coil pickups, and the pickup circuit further comprises an output jack from which audio signals are outputted from the circuit and a five-way pickup selector switch to which positive leads of the three single-coil pickups are connected, a first position of which connects a first singular one of the three single-coil pickups in a closed circuit with the output jack via the installed hum-cancellation device, a second position of which connects a first pair of the three single-coil pickups in a closed circuit with the output jack via the installed hum-cancellation device, a third position of which connects a second singular one of the three single-coil pickups in a closed circuit with the output jack via the installed hum-cancellation device, a fourth position of which connects a second pair of the three single-coil pickups in a closed circuit with the output jack via the installed hum-cancellation device, and a fifth position of which connects a third singular one of the three single-coil pickups in a closed circuit with the output jack via the installed hum-cancellation device.

15. The method of claim 12 wherein the plurality of single-coil pickups comprises three single-coil pickups.

16. The method of claim 14 wherein the respective pickup coils of the three single-coil pickups are all wound in a same direction as one another, and the hum-cancellation device has only a singular dummy coil, the input end of which is connected to the negative leads of all three of the three single-coil pickups.

17. The method of claim 14 wherein:
the three single-coil pickups comprise an outer two pickups and middle pickup residing in a position between said outer two pickups;
the respective singular pickup coils of said outer two pickups are wound in the same direction as one another;
the respective singular pickup coil of the middle pickup is wound in a reverse direction to the respective singular pickup coils of said outer two pickups; and
the hum-cancellation device has two dummy coils of reversely wound relationship to one another, among which the input end of a first of said two dummy coils is connected to the negative leads of the outer two pickups, and the input end of a second of said two dummy coils is connected to the negative lead of the middle pickup.

18. The method of claim 17 wherein said two dummy coils reside in stacked relationship to one another.

19. A dual-coil hum-cancellation device for hum cancellation purposes in electric guitar pickup circuits with single-coil pickups, said dual-coil hum-cancellation device comprising a bobbin devoid of any magnetic pole pieces, and two wire coils both wound around said bobbin.

20. A method of providing a customer with an optimally selected or customized hum-cancellation device intended for installation in a pickup circuit of an electric guitar for hum cancellation purposes, said method comprising:
receiving from a customer indication of at least one characteristic of the pickup circuit; and
performing case-specific selection or customization of the hum-cancellation device, for ultimate provision thereof to the customer, according to said at least one characteristic of the pickup circuit;
wherein said at least one characteristic of the pickup circuit comprises identified presence or absence in said pickup circuit of a reverse wound single-coil pickup whose coil winding directionally is opposite that of any other single-coil pickup in the pickup circuit, and selecting or customizing the hum-cancellation device to have either a singular dummy coil for instances characterized by absence of a reverse-wound single coil pickup, or two dummy coils, of reversely wound relationship to one another, for instances characterized by presence of a reverse-wound single-coil pickup.
